(19) United States
(12) Patent Application Publication
(10) Pub. No.: US 2024/0096055 A1
(43) Pub. Date: Mar. 21, 2024

(54) OPERATION LOG GENERATION DEVICE AND OPERATION LOG GENERATION METHOD

(71) Applicant: Nippon Telegraph and Telephone Corporation, Tokyo (JP)

(72) Inventors: Kimio TSUCHIKAWA, Musashino-shi, Tokyo (JP); Fumihiro YOKOSE, Musashino-shi, Tokyo (JP); Misa FUKAI, Musashino-shi, Tokyo (JP); Yuki URABE, Musashino-shi, Tokyo (JP); Sayaka YAGI, Musashino-shi, Tokyo (JP)

(21) Appl. No.: 18/276,196

(22) PCT Filed: Feb. 8, 2021
(86) PCT No.: PCT/JP2021/004679

§ 371 Date: Aug. 7, 2023

(51) Int. Cl. G06V 10/762; G06V 10/764

(52) U.S. Cl. CPC G06V 10/762; G06V 10/764

(57) ABSTRACT

An acquisition unit detects an operation event of a user and acquires an occurrence position of the operation event in a captured image of an operation screen. A specifying unit specifies an image of the occurrence position of the operation event from among images to be candidates for a GUI component extracted from the captured image and records the image and the operation event in association with each other. A classifying unit classifies a set of recorded images into clusters according to the similarity between the images. A generation unit generates an operation log by using an image corresponding to the operation event of each classified cluster.

### TECHNICAL FIELD

The present invention relates to an operation log generation device and an operation log generation method.

### BACKGROUND ART

In business analysis, it is effective to display an operation procedure in the form of a flowchart. When considering the business of providing services and products to customers, the procedure for operating a system for providing the same services and products is determined for each service and product, and such an operation procedure is shared among operators, using a manual or the like.

In addition, beginners are taught to how to perform the operation procedure through training or by being guided by experts, and therefore the procedure for processing the same product and service should be the same operation procedure. However, in reality, it is normal that various irregular events that were not initially expected occur. For example, a customer may change the content of an order after placing the order, a product may be out of stock, or an operator makes an operation error. It is not realistic to prescribe operation procedures for all of such irregular events, and even if possible, it is difficult for operators to remember all the operation patterns and select an appropriate procedure.

Therefore, in reality, even for the same product/service, the operation procedure is generally different for each order. In grasping the actual business situation to improve the business, it is important to comprehensively grasp all operation patterns including such irregular events. This is because procedures for irregular events are not clearly defined and, for example, it is necessary to check how to proceed, consult the person in charge of the business about how to proceed, or there is a high possibility that an error occurs in the operation procedure, which often takes a longer time than the normal operation pattern.

In such a situation, it is effective to display an operation procedure in the form of a flowchart. For example, there is a proposal for a mechanism for clarifying difference between operation procedures for different orders by arranging operation procedures for the orders and displaying flowcharts thereof, where, for each order, an operation log in which the operation time of the operator, the type of the operation (hereinafter referred to as an operation type), and information that identifies the order (hereinafter referred to as an order ID) are recorded, is used as an input.

Also, as a mechanism for enabling an analyst to acquire operation logs at a desired granularity level, there is a known technique regarding an operation screen for an GUI application of, for example, acquiring attribute values of GUI components that constitute the operation screen when an event occurs, and finding changes before and after the occurrence of the event. As a result, it is possible to extract only an event that caused changes in attribute values, that is, an operation event that is meaningful to the business, and also specify the operation part at the same time.

However, in actual business, it is common that various applications such as a mailer, a Web, a business system, Word, Excel, and a scheduler are used to proceed with business. It is necessary to develop a mechanism to acquire the attribute values of GUI components and identify changes according to the execution environment of all these applications. However, it is not realistic due to very high costs. Even when the target application is developed, if the specifications of the target execution environment change due to version upgrade, it will be necessary to modify the application accordingly. In recent years, thin client environments have become widespread in companies, for the purpose of effective utilization of computer resources and improvements in security. In a thin client environment, applications are not installed on a terminal that the user actually operates (hereinafter referred to as a client terminal), and applications are installed on another terminal (server) that is connected to the client terminal. An operation screen provided by an application is displayed as an image on the client terminal, and the user operates the application on the server, using the displayed image. In this case, the operation screen is displayed as an image on the terminal that the user actually operates, and therefore it is impossible for the client terminal to acquire the attribute values of the GUI components described above.

In addition, there is a proposal for a mechanism for acquiring operation logs by utilizing events such as keyboard inputs and mouse clicks. With this mechanism, only the events that satisfy the conditions specified in advance are recorded as operation logs for each task upon being triggered by the events of mouse clicks and inputs from the enter key of the keyboard. Using this mechanism, it is possible to extract only events that are necessary for the analyst, while omitting events that are unnecessary for the analysis.

### CITATION LIST

### Patent Literature

[PTL 1] Japanese Patent Application Laid-open No. 2015-153210

### SUMMARY OF INVENTION

### Technical Problem

However, in the prior art, it is not easy to acquire operation logs of applications. For example, an actual task is generally advanced while utilizing various applications, and it is not practical to create a mechanism for acquiring operation logs for a large number of applications. In addition, the prior art is complicated because it is necessary to specify conditions in advance.

In view of these problems, as a method for acquiring an operation log necessary for generally reproducing an operation flow regardless of an execution environment of a GUI application, a method of acquiring a captured image of an operation screen in accordance with timing when a user operates a terminal, extracting an image to be a candidate for a GUI component by using features on the image, specifying a GUI component to be operated from an event occurrence position, and reproducing an operation flow by inputting the GUI component. In this case, since there are inoperable GUI components in addition to operable GUI components on the operation screen, it is necessary to distinguish these GUI components and extract only the image of an operable GUI component.

The present invention has been made in view of the above, and an object thereof is to generally specify an operation type necessary for generation of an operation log for an operation performed on a GUI application, regardless of an execution environment of a target application.

### Solution to Problem

In order to solve the above problem and achieve the object, an operation log generation device according to the present invention includes: an acquisition unit that detects an operation event of a user and acquires an occurrence position of the operation event in a captured image of an operation screen; a specifying unit that specifies an image of the occurrence position of the operation event from among images to be candidates for a GUI component extracted from the captured image and records the image and the operation event in association with each other; a classifying unit that classifies a set of recorded images into clusters according to similarity between the images; and a generation unit that generates an operation log by using an image corresponding to the operation event of each classified cluster.

### Advantageous Effects of Invention

According to the present invention, an operation log of a GUI application can be acquired generally, regardless of the execution environment of a target application.

### BRIEF DESCRIPTION OF DRAWINGS

FIG. 1 is a schematic diagram illustrating a schematic configuration of an operation log generation device of the present embodiment.

FIG. 2 is a diagram for explaining processing of a specifying unit.

FIG. 3 is a diagram for explaining processing of a specifying unit.

FIG. 4 is a diagram for explaining processing of a specifying unit.

FIG. 5 is a flowchart illustrating an operation log generation processing procedure.

FIG. 6 is a diagram illustrating an example of a computer that executes an operation log generation program.

### DESCRIPTION OF EMBODIMENTS

Embodiments of the present invention will be described hereinafter in detail with reference to the drawings. Note that the present invention is not limited to the embodiments. Further, in the description of the drawings, the same parts are denoted by the same reference signs.

[Configuration of Operation Log Generation Device]

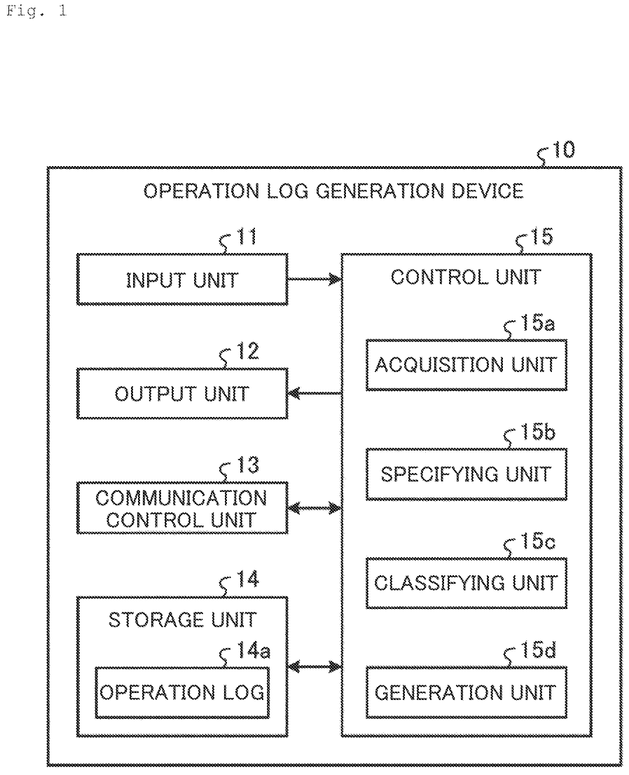

FIG. 1 is a schematic diagram illustrating a schematic configuration of an operation log generation device of the present embodiment. As illustrated in FIG. 1, an operation log generation device 10 of the present embodiment is realized by a general-purpose computer such as a personal computer and a workstation, and includes an input unit 11, an output unit 12, a communication control unit 13, a storage unit 14, and a control unit 15.

The input unit 11 is realized using an input device such as a keyboard or a mouse, and receives various types of instruction information, such as a processing start instruction for the control unit 15, in accordance with input operations performed by an operator. The output unit 12 is realized using a display device such as a liquid crystal display, a printing device such as a printer, or the like. For example, the output unit 12 displays a result of operation log generation processing to be described later.

The communication control unit 13 is realized by an NIC (Network Interface Card) or the like and controls communication between an external device and the control unit 15 via a telecommunication line such as a LAN (Local Area Network) or the Internet. For example, the communication control unit 13 controls communication between a terminal or the like operated by a user, and the control unit 15. The terminal may be mounted on the same hardware as the operation log generation device 10.

The storage unit 14 is realized using a semiconductor memory element such as a RAM (Random Access Memory) or a flash memory, or a storage device such as a hard disk or an optical disc. A processing program for operating the operation log generation device 10, data used during execution of the processing program, and the like are stored in advance in the storage unit 14 or are stored temporarily each time the processing is performed. The storage unit 14 stores an operation log 14a which is a result of the operation log generation processing to be described later. Note that the storage unit 14 may also be configured to communicate with the control unit 15 via the communication control unit 13.

The control unit 15 is realized using a CPU (Central Processing Unit) or the like, and executes a processing program that is stored in a memory. Thus, as exemplified in FIG. 1, the control unit 15 functions as an acquisition unit 15a, a specifying unit 15b, a classifying unit 15c, and a generation unit 15d. Note that each or some of these functional units may be implemented as a different piece of hardware. Also, the control unit 15 may include another functional unit.

The acquisition unit 15a detects an operation event of the user such as mouse clicks and keyboard inputs by the user, and acquires an occurrence position of the operation event in a captured image of an operation screen. Specifically, the acquisition unit 15a periodically acquires a captured image of the operation screen of the user. Also, the occurrence of an operation event is monitored.

Upon detection of the occurrence of an operation event, the acquisition unit 15a compares the captured images of the operation screen immediately before and after the operation event. When a change occurs in the captured image, the acquisition unit 15a acquires a position where the change has occurred as an occurrence position of the operation event on the operation screen. Thus, the acquisition unit 15a can acquire the occurrence position of the operation event generated for the operable GUI component.

For example, the acquisition unit 15a has the function of detecting the occurrence of an operation event such as a keyboard input or a mouse click, and the function of, upon detecting an operation event, notifying the specifying unit 15b described later of an operation event occurrence of time, an operation event occurrence position, and a captured image on the operation screen obtained immediately prior to the occurrence of the operation event. The captured image on the operation screen obtained immediately prior to the occurrence of the operation event can be acquired by, for example, periodically acquiring image capture and comparing it with the event occurrence time.

Regarding the detection of the occurrence of an operation event, the acquisition unit 15a can be realized by using a global hook in the case of the Windows (registered trademark) OS, for example. Similarly, the acquisition unit 15a can acquire the event occurrence position by using a global hook in the case of a mouse click, for example.

In addition, the acquisition unit 15a acquires the occurrence position of the operation event when the captured image of the operation screen obtained before and after the occurrence of the detected operation event changes. Regarding a keyboard input, for example, since a normal keyboard input involves an input of a character string, the occurrence position of the operation event can be specified by comparing the captured images obtained before and after the occurrence of the operation event. Thus, the acquisition unit 15a can surely detect an operation event in which a change has occurred in the screen. Note that a change is not limited to occurring at one point, and may occur within an area. A change may occur at any coordinate point included in the area. In addition, although keyboard inputs include operations that do not involve the input of a character string, such as a Tab key input, a direction key input, and a shift key input, these are often meaningless in analysis and are therefore ignored in the present embodiment.

The acquisition unit 15a may acquire and record information on the type of the operation event (mouse click, keyboard input).

When detecting an image change on the operation screen before and after the operation event, the acquisition unit 15a may compare captured images of the entire operation screen or compare images around the occurrence position of the operation event.

The specifying unit 15b specifies an image of the occurrence position of the operation event among images to be candidates for GUI components extracted from the captured image by processing to be described later, and records the image and the operation event in association with each other. Specifically, the specifying unit 15b extracts an image to be a candidate for a GUI component from the acquired captured image obtained immediately before the occurrence of the operation event, specifies on which image the operation event has occurred from the occurrence position of the operation event, and stores operation event information including the occurrence position, the occurrence time and the type of the operation event and the image in association with each other.

For example, the specifying unit 15b extracts an image to be a candidate for a GUI component of a predetermined format from the acquired captured image by using features on the image. The specifying unit 15b specifies an edge of a GUI component by using, as a feature, the difference in color between an area occupied by each GUI component and the other area by using an OpenCV (Open Source Computer Vision Library) or the like. Then, the specifying unit 15b crops an image to be a candidate for a GUI component from the operation image by using the specified edge as a contour and cropping a circumscribed rectangle that includes the edge.

In so doing, the specifying unit 15b extracts an image to be a candidate for the GUI component by cropping an image of a predetermined format and an image around the image, from the captured image. Accordingly, when the operation flow is visualized by using the image of the result of the processing by the generation unit 15d described later, the operation part on the operation screen is easily recognized by the user. Also, similar images of GUI components, such as text boxes, can be distinguished.

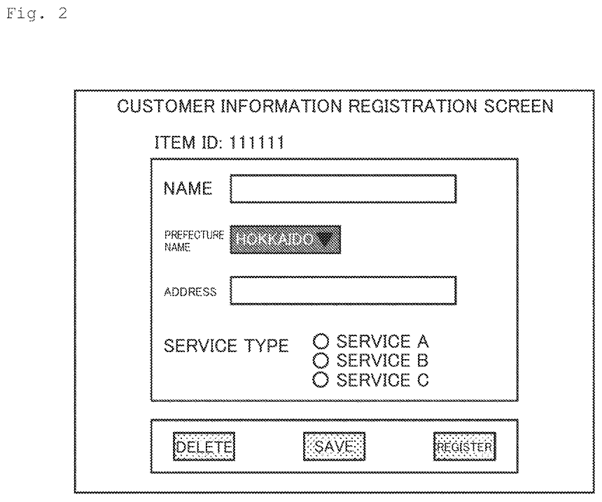

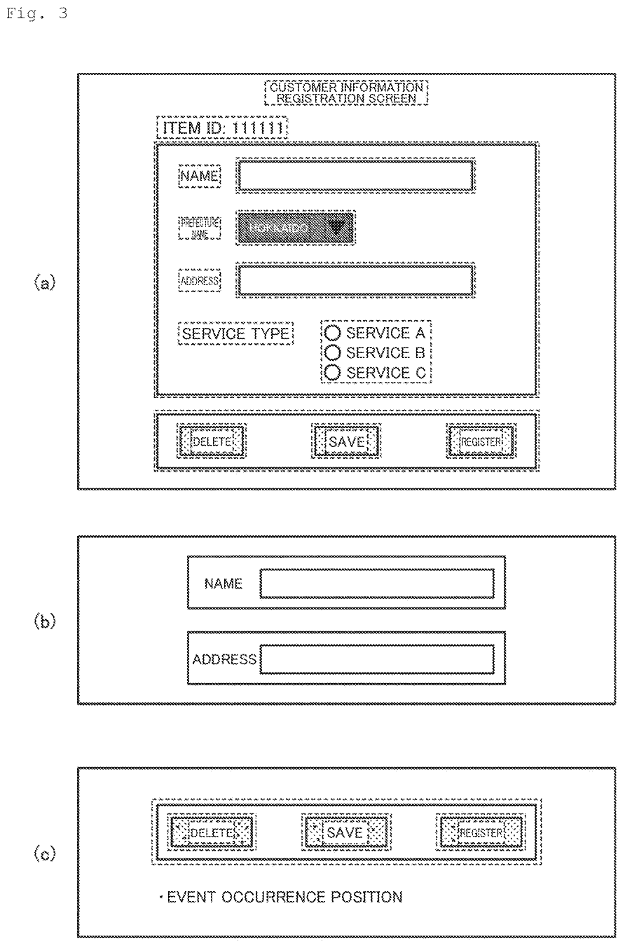

Here, FIGS. 2 to 4 are diagrams for explaining the processing performed by the specifying unit 15b. FIGS. 3(a) to 3(c) illustrate the case where the specifying unit 15b extracts an image to be a candidate for the GUI component from the captured image from the operation screen shown in FIG. 2 and associates the image with the operation event. More specifically, FIG. 3(a) shows an example of an image cropped as the image, as shown by the broken line. FIG. 3(b) shows an example of extracting an image of a text box which can be an image of an operation target. As shown in FIG. 3(b), the specifying unit 15b crops an image including an image around a text box, thereby discriminating different text boxes on the same operation screen. In the example shown in FIG. 3(b), for example, by cropping an image so as to include a character image around the specified text box, it is possible to distinguish between a text box for inputting a name and a text box for inputting an address. Furthermore, the similarity is determined except for a common area, so that the classification can be performed with higher accuracy in the classifying unit 15c described later.

Then, the specifying unit 15b specifies an image including the occurrence position of the operation event from among the cropped images, and stores the specified image and operation event information including the occurrence position of the operation event, the occurrence time of the operation event, and the operation event type, in the storage unit 14 in association with each other.

In so doing, if the plurality of cropped images are in a nested relationship as shown in FIG. 3(c), the specifying unit 15b specifies the image located on the innermost side among images including the occurrence position of the operation event. The specifying unit 15b may specify the outermost image among images including the occurrence position of the operation event. Specifically, the specifying unit 15b only needs to be able to specify one image for each operation event.

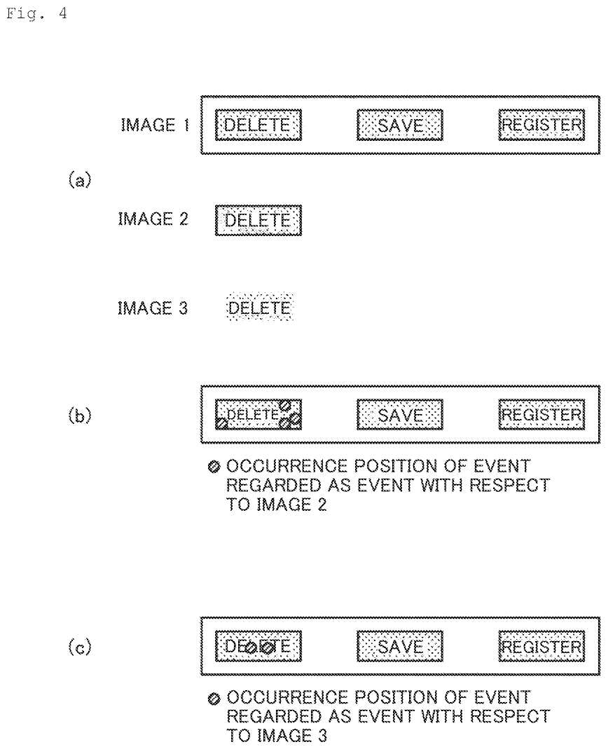

FIG. 4(a) illustrates images (images 1 to 3) cropped from FIG. 3(c). FIGS. 4(b) and 4(c) show examples of the occurrence position of an operation event regarded as an operation performed on each image. For example, FIG. 4(b) shows an example of the occurrence position of an operation event which is regarded as an operation for an image 2 when specifying the outermost image.

The specifying unit 15b may transfer the specified image, the occurrence position, the type of the operation event and the occurrence time to the classifying unit 15c described below without storing them in association with each other in the storage unit 14.

Return to the explanation of FIG. 1. The classifying unit 15c classifies a set of recorded images into clusters according to similarity between the images. This processing is intended to classify the same operation type into the same cluster for operations performed on the GUI. For example, the classifying unit 15c classifies the images according to the similarity of display positions in the captured images of the operation screens of the respective images. Thus, images representing GUI components displayed at the same position on the operation screen are classified into the same cluster. When the configuration of the operation screen is fixed, all GUI components are always displayed at the same position, so that images obtained by cropping GUI components of the same operation event can be classified into the same cluster, that is, the same operation type.

Alternatively, the classifying unit 15c classifies the images according to the similarity of the respective images on the images. Thus, images obtained by cropping GUI components of the same operation event are classified into the same cluster. When the configuration of the operation screen changes dynamically, since the display position of each GUI component is changed, the images cannot be classified from the similarity of the display position. Since GUI components of the same operation event are the same image, the images are classified by using the similarity on the images. For the determination of the similarity of the images, it is possible to determine the similarity using, for example, pattern matching or various features and feature points.

The classifying unit 15c imparts a cluster ID for identifying each cluster to a classified cluster. That is, the cluster ID corresponds to an operation type.

The generation unit 15d generates the operation log 14a by using an image corresponding to the operation event of each classified cluster. Specifically, the generation unit 15d records an image of a cluster in association with a cluster ID and an operation event occurrence time for each operation event, generates the operation log 14a, and stores the generated operation log 14a in the storage unit 14. The generation unit 15d may generate the operation log 14a by further associating the operation event type with the image.

When the generation unit 15d generates the operation log 14a, the analyst may give an arbitrary character string to the image included in the cluster, for each cluster, in order for the analyst to distinguish the image included in the cluster, and the classifying unit 15c may generate a flow by using the character string. Also, the classifying unit 15c can extract a characteristic character string by an OCR with respect to the image included in the cluster and apply it as a label.

[Operation Log Generation Processing]

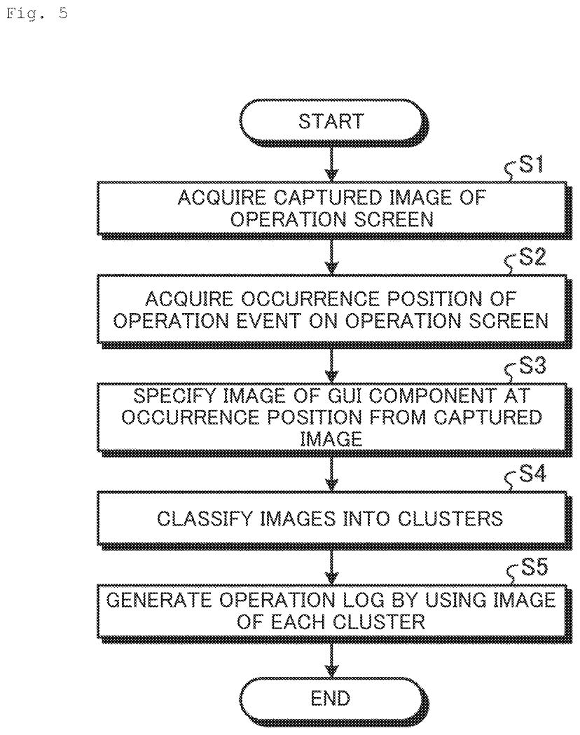

Next, the operation log generation processing by the operation log generation device 10 according to the present embodiment will be described with reference to FIG. 5. FIG. 5 is a flowchart illustrating an operation log generation processing procedure. The flowchart shown in FIG. 5 is started when, for example, an operation is input by a user to give an instruction to start the procedure.

First, the acquisition unit 15a periodically acquires a captured image of an operation screen of the user (step S1). When the acquisition unit 15a detects an operation event of the user, the acquisition unit 15a compares captured images of the operation screen obtained immediately before and immediately after the operation event, and acquires an occurrence position on the operation screen when a change has occurred in the captured image (step S2).

Next, the specifying unit 15b specifies an image of the occurrence position of the operation event from among images to be candidates for GUI components extracted from the captured image (step S3), and records the image and the operation event in association with each other. For example, the specifying unit 15b specifies an image to be a candidate for a GUI component of a predetermined format from the captured image by using features on the image, and crops the specified image from the captured image. Then, an image including the occurrence position of the operation event is specified out of the cropped image, and the specified image and operation event information including the occurrence position of the operation event, the occurrence time of the operation event, and the operation event type are stored in the storage unit 14 in association with each other.

Next, the classifying unit 15c classifies the set of recorded images into clusters according to the similarity between the images (step S4). For example, the classifying unit 15c classifies the images according to the similarity of the display positions in the captured images of the respective images. Alternatively, the classifying unit 15c classifies the images according to the similarity of the respective images on the images.

Then, the generation unit 15d generates an operation log by using an image corresponding to the operation event of each cluster (step S5). For example, the generation unit 15d records images included in each classified cluster in association with the cluster ID and the operation event occurrence time, and generates the operation log 14a. The generation unit 15d stores the generated operation log 14a in the storage unit 14. Alternatively, the generation unit 15d outputs the operation log 14a to, for example, a device that creates an operation flow. In this manner, a series of operation log generation processing steps ends.

As described above, in the operation log generation device 10 of the present embodiment, the acquisition unit 15a detects an operation event of a user and acquires an occurrence position of the operation event in a captured image of the operation screen. The specifying unit 15b specifies an image of the occurrence position of the operation event from among images to be candidates for GUI components extracted from the captured image, and records the image and the operation event in association with each other. The classifying unit 15c classifies a set of recorded images into clusters according to the similarity between images. The generation unit 15d generates the operation log 14a by using an image corresponding to the operation event of each classified cluster.

Thus, the operation log generation device 10 can easily and automatically acquire the operation log 14a of a GUI application without preparing teacher data or designating a condition in advance, regardless of the type of the GUI application. Also, the operation log generation device 10 can extract only an operation event performed on an operable GUI component.

The acquisition unit 15a acquires the occurrence position of the operation event when the captured image of the operation screen before and after the occurrence of the detected operation event changes. Thus, the acquisition unit 15a can detect an operation event in which a change is surely generated on the screen, and extract only the operation event generated for an operable GUI component.

The classifying unit 15c classifies the images according to the similarity of the display positions in the captured image of each image. Therefore, when the configuration of the operation screen does not change dynamically, the operation log generation device 10 can classify images obtained by cropping the same GUI component into the same cluster.

The classifying unit 15c classifies the images according to the similarity of the images on the respective images. Thus, the operation log generation device 10 can classify images obtained by cropping the same GUI component into the same cluster when the configuration of the operation screen is dynamically changed.

The specifying unit 15b extracts an image to be a candidate for the GUI component by cropping an image of a predetermined format and an image around the image, from the captured image. Thus, when the image is visualized as an operation flow, the user can easily recognize an operation part on the operation screen. In addition, it is possible to easily distinguish GUI components such as text boxes with similar images.

[Program]

A program in which the processing executed by the operation log generation device 10 according to the foregoing embodiment is written in a language executable by a computer can be created. As an embodiment, the operation log generation device 10 can be implemented by having an operation log generation program that executes the foregoing operation log generation processing installed on a desired computer as packaged software or online software. For example, an information processing apparatus can be caused to function as the operation log generation device 10 by causing the information processing apparatus to execute the operation log generation program described above. The information processing apparatus mentioned here may be a desktop or laptop personal computer. In addition, the scope of the information processing apparatus includes mobile communication terminals such as a smartphone, a mobile phone, and a PHS (Personal Handyphone System), and slate terminals such as a PDA (Personal Digital Assistant). Furthermore, the functions of the operation log generation device 10 may be implemented in a cloud server.

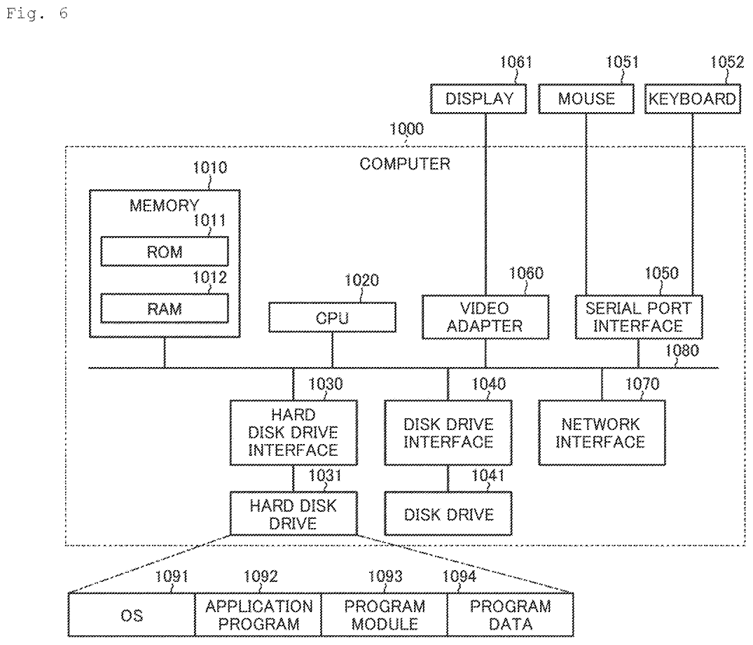

FIG. 6 is a diagram illustrating an example of the computer that executes the operation log generation program. A computer 1000 has, for example, a memory 1010, a CPU 1020, a hard disk drive interface 1030, a disk drive interface 1040, a serial port interface 1050, a video adapter 1060, and a network interface 1070. These components are connected to each other via a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to the hard disk drive 1031. The disk drive interface 1040 is connected to the disk drive 1041. A detachable storage medium such as a magnetic disk or an optical disc is inserted into the disk drive 1041, for example. A mouse 1051 and a keyboard 1052, for example, are connected to the serial port interface 1050. A display 1061, for example, is connected to the video adapter 1060.

Here, an OS 1091, an application program 1092, a program module 1093, and program data 1094, for example, are stored in the hard disk drive 1031. Each piece of information described in the above embodiment is stored in, for example, the hard disk drive 1031 or the memory 1010.

In addition, the operation log generation program is stored in the hard disk drive 1031 as, for example, the program module 1093 in which an instruction executed by the computer 1000 is written. Specifically, the program module 1093 in which each processing executed by the operation log generation device 10 described in the foregoing embodiment is stored in the hard disk drive 1031.

Also, data used for information processing based on the operation log generation program is stored in, for example, the hard disk drive 1031 as the program data 1094. Then, the CPU 1020 reads out the program module 1093 and the program data 1094 stored in the hard disk drive 1031 into the RAM 1012 when necessary, and executes each of the above-described procedures.

Note that the program module 1093 or the program data 1094 according to the operation log generation program may be stored in, for example, a detachable recording medium rather than being stored in the hard disk drive 1031, and may be read by the CPU 1020 via the disk drive 1041 or the like. Alternatively, the program module 1093 and the program data 1094 according to the operation log generation program may be stored in another computer connected via a network such as a LAN or a WAN (Wide Area Network), and read by the CPU 1020 via the network interface 1070.

Although an embodiment to which the invention made by the inventors is applied has been described above, the present invention is not limited by the description and the drawings that form a part of the disclosure of the present invention according to the present embodiment. That is to say, other embodiments, examples, operation techniques, and the like made by those skilled in the art on the basis of the present embodiment are all included in the scope of the present invention.

### REFERENCE SIGNS LIST

10 Operation log generation device
11 Input unit
12 Output unit
13 Communication control unit
14 Storage unit
14a Operation log
15 Control unit
15a Acquisition unit
15b Specifying unit
15c Classifying unit
15d Generation unit

1. An operation log generation device, comprising:
an acquisition unit, implemented using one or more computing devices, configured to detect an operation event and acquire an occurrence position of the operation event in a captured image of an operation screen;
a specifying unit implemented using one or more computing devices, configured to specify an image of the occurrence position of the operation event, from among candidate images, for a GUI component extracted from the captured image and record the image and the operation event in association with each other;
a classifying unit, implemented using one or more computing devices, configured to classify a set of recorded images into clusters based on similarities between the images; and
a generation unit, implemented using one or more computing devices, configured to generate an operation log by using an image corresponding to the operation event of each classified cluster.

2. The operation log generation device according to claim 1, wherein the acquisition unit is configured to, based on the captured image before and after the occurrence of the detected operation event being changed, acquire the occurrence position of the operation event.

3. The operation log generation device according to claim 1, wherein the classifying unit is configured to classify the images based on at least one of the similarities between the images or similarities of a display position of each image in the captured image.

4. The operation log generation device according to claim 1, wherein the specifying unit is configured to extract a candidate image for the GUI component by cropping a first image of a predetermined format and a second image around the first image from the captured image.

5. An operation log generation method executed by an operation log generation device, the operation log generation method comprising:
detecting an operation event and acquiring an occurrence position of the operation event in a captured image of an operation screen;
specifying an image of the occurrence position of the operation event, from among candidate images, for a GUI component extracted from the captured image and recording the image and the operation event in association with each other;
classifying a set of recorded images into clusters based on similarities between the images; and
generating an operation log by using an image corresponding to the operation event of each classified cluster.
